(19) United States
(12) Patent Application Publication
(10) Pub. No.: US 2001/0014914 A1
(43) Pub. Date: Aug. 16, 2001

(54) METHODS AND APPARATUS FOR GATHERING AND PROCESSING INFORMATION GENERATED IN RESPONSE TO A BROADCAST SIGNAL

(76) Inventors: YASUHIRO MURAMATSU, TOKYO (JP); YURIKO KISHITAKA, SAITAMA (JP); YOSHIMOTO MURATSUBAKI, KANAGAWA (JP); MASAYUKI MIYAGAWA, KANAGAWA (JP); NAOKI KIGAWA, KANAGAWA (JP); KAZUHIRO AKAIKE, KANAGAWA (JP); MIKA ITO, TOKYO (JP)

Correspondence Address: OBLON, SPIVAK, MCCLELLAND, MAIER & NEUSTADT, 1755 JEFFERSON DAVIS HIGHWAY, FOURTH FLOOR, ARLINGTON, VA, 22202, US

(21) Appl. No.: 09/407,100

(22) Filed: Sep. 27, 1999

Related U.S. Application Data
(62) Division of application No. 08/701,747, filed on Aug. 22, 1996, now abandoned.

(30) Foreign Application Priority Data
Aug. 24, 1995 (JP) P07-215626

(51) Int. Cl. G06F 15/173

(52) U.S. Cl. 709/224

(57) ABSTRACT

An information processing apparatus for processing information responsive to a broadcast program in a short duration of time. A viewer inputs information responsive to the broadcasting program presented on a display unit using an input module. The viewer may input the image and sound presented on the display unit to an information processing apparatus through an STB, and then process the image and sound by operating the input module 25. The information processing apparatus transmits the processed image or the data input through the input module 25 to a broadcasting station via the Internet any time convenient to the broadcasting station. The broadcasting station receives and gathers data from numerous viewers through a computing unit linked to the Internet.

### BACKGROUND OF THE INVENTION

1. Field of the Invention

The present invention relates to an information processing apparatus and method, broadcasting apparatus and data gathering method, and more specifically, to the information processing apparatus and method, broadcasting apparatus and data gathering method, in which information responsive to a broadcast signal provided by a broadcasting station is transmitted to the broadcasting station via a wide area communications network such as the Internet.

2. Description of the Related Art

Broadcasting stations supply programs to a large number of viewers or listeners. When any listener or viewer who listens to or watches a program wants to convey his or her response or information about the program back to the broadcasting station, he or she probably uses mail, telephone or facsimile service.

Information from the viewer is expected to reach the broadcasting station by mail within a few days. Over the telephone or facsimile, information from each viewer is individually received by the operator of telephone or facsimile at the broadcasting side.

Information given by numerous viewers is converted into data in an easy-to-handle format, and then gathered, and then reflected in broadcasting activity.

To feed back the viewer's response to the broadcasting station using mail, telephone and facsimile service, a great deal of time is consumed before the information from numerous viewers is gathered, and thus it is difficult to reflect the response in a program currently in progress.

### SUMMARY OF THE INVENTION

Accordingly, it is an object of the present invention to provide an information processing apparatus and method, broadcasting apparatus and data gathering method, wherein information from numerous viewers is transmitted in an easy-to-handle data format so that a broadcasting station may easily process the information from the numerous viewers.

An information processing apparatus according to the present invention comprises input means for inputting information responsive to a broadcast signal broadcast by a broadcasting station, memory means for storing the information until a transmission instruction is given, and transmitter means for transmitting the information to the broadcasting station.

In the information processing apparatus, the input means inputs the information responsive to the broadcast signal broadcast by the broadcasting station, the memory means stores the information until a transmission instruction is given, and the transmitter means transmits the information to the broadcasting station.

The information from viewers is transmitted at the time convenient to the broadcasting station, and the broadcasting station can handle the information from the viewers more easily.

An information processing apparatus according to the present invention comprises input means for inputting information responsive to a broadcast signal broadcast by a broadcasting station, memory means for storing the information until a transmission instruction is given, and transmitter means for transmitting the information to the broadcasting station via a wide-area computer communications network.

In the information processing apparatus, the input means inputs the information responsive to the broadcast signal broadcast by the broadcasting station, the memory means stores the information until the transmission instruction is given, and the transmitter means transmits the information to the broadcasting station via the wide-area computer communications network.

The data from viewers is transmitted in a format that is easy to handle in the broadcasting station, and for example, information from numerous viewers from various countries around the globe may be transmitted to and processed at the broadcasting station.

A broadcasting apparatus according to the present invention comprises broadcasting means for broadcasting a broadcast signal, transmission instruction means for giving an instruction to transmit the information responsive to the broadcast signal back to the broadcasting station, and receiving means for receiving the information.

In the broadcasting apparatus, the broadcasting means broadcasts the broadcast signal, the transmission instruction means gives the instruction to transmit the information responsive to the broadcast signal back to the broadcasting station, and the receiving means receives the information.

The broadcasting station can thus receive the information from viewers at any time convenient to the broadcasting station, and easily handles the information from the viewers.

A data gathering method according to the present invention comprises the steps of broadcasting a broadcast signal, giving an instruction to transmit the information responsive to the broadcast signal to the broadcasting station, and receiving the information.

In the data gathering method, the broadcast signal is broadcast, the instruction is given to transmit the information responsive to the broadcast signal to the broadcasting station, and the information is received.

The broadcasting station can thus receive the information from viewers at any time convenient to the broadcasting station, and easily handles the information from the viewers.

An information processing method according to the present invention comprises the steps of inputting the information responsive to the broadcast signal broadcast by a broadcasting station, storing the information until a transmission instruction is provided, and transmitting the information to the broadcasting station.

In the information processing method, the information responsive to the broadcast signal broadcast by the broadcasting station is input, the information is stored until the transmission instruction is provided, and the information is transmitted to the broadcasting station.

The information from viewers is transmitted at the time convenient to the broadcasting station, and the broadcasting station can handle the information from the viewers more easily.

An information processing method according to the present invention comprises the steps of inputting the information responsive to the broadcast signal broadcast by a broadcasting station, storing the information until a transmission instruction is provided, and transmitting the information to the broadcasting station via a wide-area computer communications network.

In the information processing method, the information responsive to the broadcast signal broadcast by the broadcasting station is input, the information is stored until the transmission instruction is provided, and the information is transmitted to the broadcasting station via the wide-area computer communications network.

The data from viewers is transmitted in a format that is easy to handle in the broadcasting station, and for example, information from numerous viewers from various countries around the globe may be transmitted to and processed at the broadcasting station.

### BRIEF DESCRIPTION OF THE DRAWINGS

FIG. 1 shows a broadcasting system in which an information processing apparatus according to the present invention is linked to the Internet.

FIG. 2 is a block diagram showing the configuration of an information processing apparatus according to an embodiment of the present invention.

FIG. 3 is a block diagram showing the configuration of the computing module in the embodiment in FIG. 2.

FIG. 4 is a flow diagram showing the process taken in the embodiment in FIG. 2

### DESCRIPTION OF THE PREFERRED EMBODIMENT

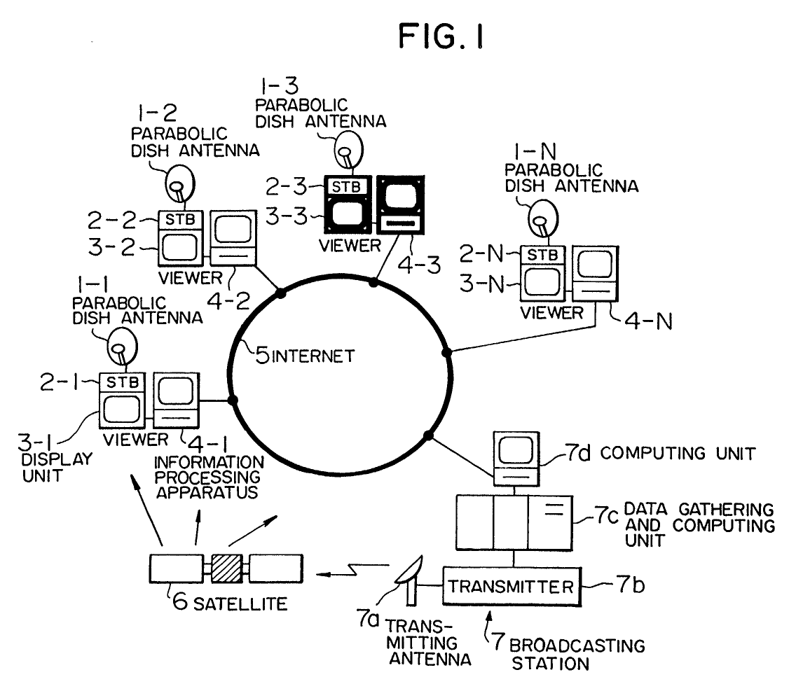

FIG. 1 shows information processing apparatuses of the present invention linked to the Internet. In this configuration, a broadcasting station 7 transmits broadcast data to a satellite 6 via a transmitting antenna 7a from a transmitter 7b (broadcasting means, transmission instruction means). The satellite 6 broadcasts the broadcast data to a large number of viewers.

Viewers receive the program transmitted from the satellite 6 through their respective parabolic dish antennas 1-1 through 1-N at set-top boxes (STBs) 2-1 through 2-N. The received program is then displayed on display units 3-1 through 3-N such as television sets.

The viewers who listen to or view the program can transmit responses or information to the program input by operating respective information processing apparatuses (personal computers) 4-1 through 4-N to the broadcasting station 7 via the Internet 5, which serves as a wide-area computer communications network in this case. The broadcasting station 7 receives, at its computing unit (computer) 7d (receiving means) linked to the Internet 5, data transmitted by numerous viewers, and gathers the data with its data gathering and computing unit (computer) 7c.

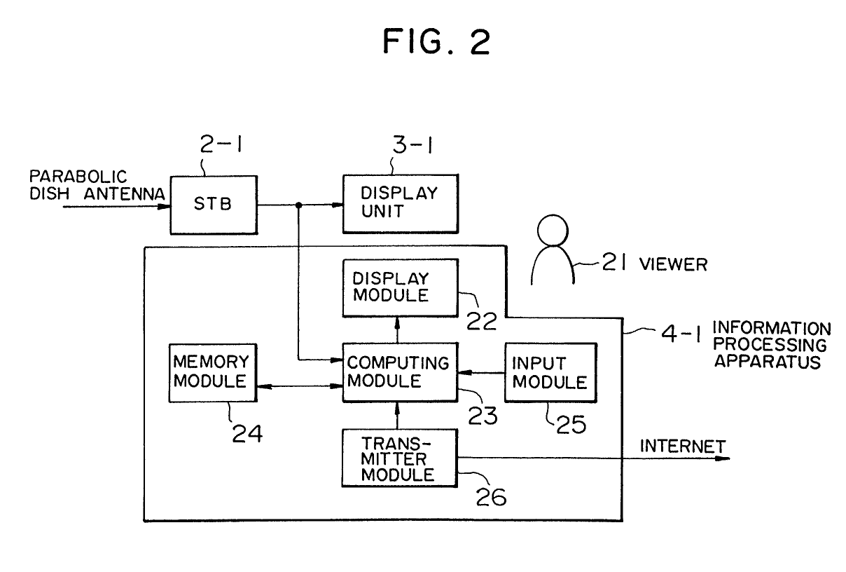

FIG. 2 shows the configuration of the information processing apparatus 4-1 (4-2 through 4-N are identical to 4-1) according to an embodiment of the present invention. In this configuration, operating an input module 25 (input means) such as a keyboard or a mouse, a viewer 21 inputs, to a computing module (CPU) 23, information responsive to the program presented on the display unit 3-1. The viewer 21 can verify the input information or data on the screen of a display module (monitor display) 22. If necessary, the viewer 21 can input to the computing module 23 the program received by STB2-1. The viewer 21 can also transmit an image or voice in the program, manipulated by operating the input module 25 to the broadcasting station 7 from a transmitter module 26 via the Internet 5. The computing module 23 converts the data created by the viewer 21 to a data format in which the broadcasting station 7 handles the data.

When the computing module 23 stores the data input by the viewer 21 until the transmission instruction is received from the broadcasting station 7, the computing module 23 writes the data onto a memory module 24 (memory means) such as a hard disk, a floppy disk or a magneto-optical disk, and then reads the data from the memory module 24 at the moment the transmission instruction is received from the broadcasting station 7. The transmission instruction is transmitted from a transmitter 7b via the satellite 6, and then received by STB2-1. The STB2-1 is adapted to supply the transmission instruction to the computer module 23.

When the broadcasting station 7 transmits the data input by the viewer 21 in synchronization with a bidirectional synchronizing signal attached to an image signal, the computing module 23 holds the data waiting for the synchronizing signal, and then outputs the data to the transmitter module 26 (transmitter means) at the moment the synchronizing signal is received. When the data is asynchronously transmitted, the computing module 23 supplies the data to the transmitter module 26 without waiting for the synchronizing signal. The transmitter module 26 issues the data supplied by the computing module 23 to the broadcasting station 7 via the Internet 5.

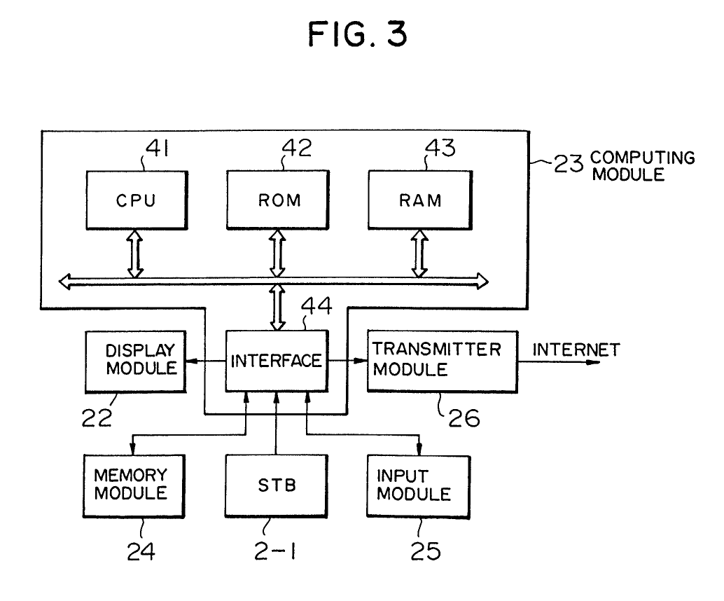

FIG. 3 shows the configuration of the computing module 23 according to this embodiment. In this configuration, a CPU 41 is provided. Under the program stored in ROM 42, the CPU 41 supplies the data the viewer 21 has input by operating the input module 25 to the transmitter module 26 via an interface 44. RAM 43 stores data and programs required for various processing performed by the CPU 41, as required.

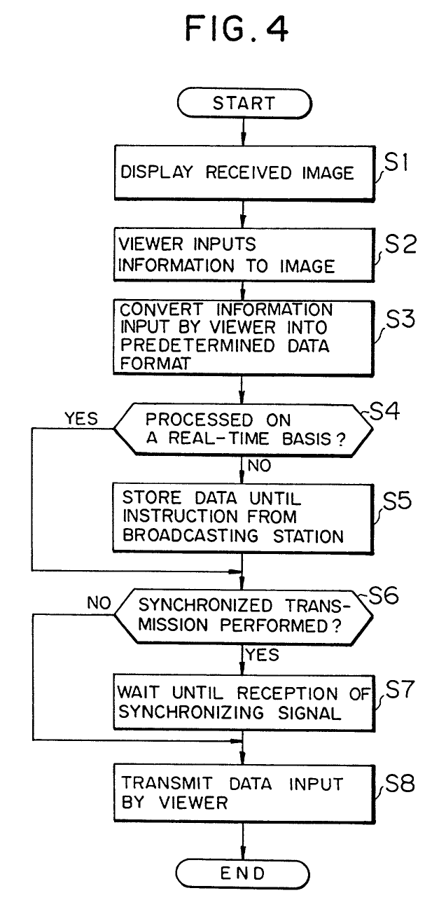

Referring to the flow diagram in FIG. 4, the operation in the above embodiment is now discussed.

At step S1, STBs 2-1 through 2-N receive programs the broadcasting station 7 transmits via the satellite 6, and supply the programs or broadcast signals to the display units 3-1 through 3-N to present them thereon. Next, at step S2, viewers 21 watch the programs presented on the display units 3-1 through 3-N, and then input their responsive information or data to the programs to the computing module 23.

At step S3, the CPU 41 converts the data input by the viewers 21 to the data in the predetermined data format.

At step S4, a determination is made of whether the data input by the viewers 21 is stored or processed in real-time by the time when a transmission instruction is receivecd. To store the data, the sequence goes to step S5. At step S5, the CPU 41 writes the data onto the memory module 24 via the interface 44. Upon receiving a transmission instruction from the broadcasting station 7, the CPU 41 reads the data from the memory module 24 via the interface 44. The sequence then goes to step S6.

To transmit the input data to the broadcasting station 7 in real-time, neither data writing to nor reading from the memory module 24 are performed (step S5 skipped). The sequence goes to step S6 from step S4.

At step S6, a determination is made of whether the data input by the viewers 21 is transmitted in synchronization with the synchronizing signal supplied by the broadcasting station 7. To perform a synchronized transmission, the sequence goes to step S7. At step S7, the computing module 23 waits for a synchronizing signal to come from the broadcasting station 7, and at the moment the synchronizing signal is supplied, the sequence goes to step S8. When the synchronized transmission is not performed, the computing module 23 does not wait for the synchronizing signal (with step S7 skipped). The sequence goes to step S8 from step S6.

At step S8, the CPU 41 feeds the data input by the viewers 21 to the transmitter module 26 via the interface 44. The transmitter module 26 transmits the data to the broadcasting station 7 via the Internet 5.

As described above, the viewers 21 can transmit information responsive to the program to the broadcasting station 7 via the Internet 5. The broadcasting station 7 receives the data transmitted by the viewers 21 through the computing unit 7d linked to the Internet 5, and then gathers data transmitted by numerous viewers with the data gathering and computing unit 7c.

In the above embodiment, the data written on the memory module 24 is read at the moment the transmission instruction is received from the broadcasting station 7. The viewers 21 may read and transmit their data at any desired timing by operating the input module 25.

In the above embodiment, the viewers use the Internet to transmit the data to the broadcasting station 7. Dedicated CATV (cable television) broadcasting channels, optical fiber cable channels, and radiowave channels such as ground-wave and satellite channels may be used.

In this case, the transmitter module 26 needs modifying to be compatible with the channel in use to the broadcasting station 7. For example, for a dedicated CATV channel, a dedicated CATV driving apparatus is used as the transmitter module 26. If the channel is made up of an optical fiber cable, an optical output control circuit is used as the transmitter module 26. Furthermore, if the data is transmitted on a ground wave or satellite wave, a radio transmitter is used as the transmitter module 26.

The input module 25 in the above embodiment may be provided with a sound input device, such as a microphone for inputting sounds. The input module 25 may also be provided with a moving-image input device, such as a video camera, for inputting a moving image. Furthermore, the input module 25 may be provided with a still-image input device such as a video camera, an electronic still camera, or scanner, for inputting a still image. Pictures and messages may also be input through an image input device such as a tablet and pen, a character input device such as a tablet, pen and keyboard, and a character recognition device for inputting a message. Furthermore, the input module 25 may be provided with an external memory device such as a floppy disk drive or MO (magneto-optical) disk drive to read and use any past data recorded.

In this embodiment, the memory module 24 employs a writable storage medium. If fast writing and reading of data are required of the memory module 24, RAM may be employed. To store a vast amount of data, an auxiliary storage device such as a hard disk drive may be employed as the memory module 24. When the data needs to be stored for a long period of time, an external memory device having a detachable storage medium such as a floppy disk or MO disk may be employed as the memory module 24.

In the above embodiment, the broadcasting station 7 is a television broadcasting station using the satellite 6. The present invention finds applications in DSS (digital satellite broadcasting system), wire-broadcasting, ground-wave television broadcasting, bidirectional wire-broadcasting, character broadcasting for transmitting text and image only, radio broadcasting for transmitting sound and the like.

The present invention also finds applications in activities that need a real-time service, typically in questionnaire gathering and election polls. The present invention may also be applied to services that need an interactive feature. Furthermore, the present invention may be applied to services that need both interactive and real-time features, for example, to viewer-participating programs, pari-mutuel ticket buying, stock buying, and the like.

What is claimed is:

1. An information processing apparatus comprising:
input means for inputting, at a receiving side, information responsive to a broadcast signal broadcast by a broadcasting station;
memory means for storing the information until a transmission instruction is given; and
transmitter means for transmitting the information to the broadcasting station.

2. An information processing apparatus provided with a broadcast receiving unit for receiving a program broadcast by a broadcasting station and a computer for performing predetermined processes, said apparatus comprising:
input means for inputting information responsive to a broadcast signal broadcast by the broadcasting station;
memory means for storing the information until a transmission instruction is given; and
transmitter means for transmitting the information to the broadcasting station via a wide-area computer communications network.

3. A broadcasting apparatus comprising:
broadcasting means for broadcasting a broadcast signal;
transmission instruction means for giving an instruction to transmit information responsive to the broadcast signal to the broadcasting station; and
receiving means for receiving the information.

4. A data gathering method comprising the steps of:
broadcasting a broadcast signal;
giving an instruction to transmit information responsive to the broadcast signal to the broadcasting station; and
receiving the information.

5. An information processing method comprising the steps of:
inputting information responsive to the broadcast signal broadcast by a broadcasting station;
storing the information until a transmission instruction is provided; and
transmitting the information to the broadcasting station.

6. An information processing method for receiving a program broadcast by a broadcasting station and performing predetermined processes by means of a computer, said method comprising the steps of:
inputting information responsive to the broadcast signal broadcast by a broadcasting station;
storing the information until a transmission instruction is provided; and
transmitting the information to the broadcasting station via a wide-area computer communications network.

7. The information processing apparatus according to claim 1, wherein said broadcasting station is a satellite broadcasting station and said transmitter means for transmitting the information from the receiving side to the broadcasting station is means employing wire.

8. The information processing apparatus according to claim 7, wherein said transmitter means is the Internet.

9. The information processing apparatus according to claim 1, wherein said broadcasting station is a commercial ground-wave broadcasting station for television, and said transmitter means for transmitting the information from the receiving side to the broadcasting station is means employing a telephone line.
